(19) United States
(12) Patent Application Publication
(10) Pub. No.: US 2011/0167270 A1
(43) Pub. Date: Jul. 7, 2011

(54) SECURE KEY AUTHENTICATION METHOD FOR COMMUNICATION NETWORK

(76) Inventors: Jang Yeon LEE, Seongnam-si (KR); Okyeon Yi, Seoul (KR); Jin Woong Cho, Seoul (KR); Hyun Seok Lee, Goyang-si (KR); Ju Sung Kang, Seoul (KR)

(21) Appl. No.: 12/693,466

(22) Filed: Jan. 26, 2010

(30) Foreign Application Priority Data
Jan. 4, 2010 (KR) 10-2010-0000176

(51) Int. Cl. H04L 9/32; H04L 9/00; H04L 9/14; G06F 7/58

(52) U.S. Cl. 713/170; 380/270; 380/46; 708/250

(57) ABSTRACT

A key authentication method between a user equipment (UE) and a serving network (SN) for binary CDMA network and a key re-authentication method during which the UE performs a handover within the same SN in binary CDMA network are provided. The key authentication method for the user equipment includes receiving a terminal authentication request message from a wireless access point, transmitting a terminal authentication response message that includes identification information for the user terminal, receiving user authentication request message that includes at least two random numbers and code information for message authentication from the wireless access point, and transmitting a user authentication response message that comprises first information that is generated using a master key.

### CROSS-REFERENCE TO RELATED APPLICATION(S)

This application claims the benefit under 35 U.S.C. §119(a) of a Korean Patent Application No. 10-2010-0000176 filed with the Korean Intellectual Property Office on Jan. 4, 2010, the entire disclosure of which is incorporated herein by reference for all purposes.

### TECHNICAL FIELD

The following description generally relates to a secure key authentication method for a communication network, and more specifically, to a method for key authentication between a user equipment and a service network and a key re-authentication for handover in a binary code division multiple access (CDMA) network.

### BACKGROUND

Generally, a binary CDMA technology is designed to resolve a frequency allocation problem in accordance with the coexistence of various wireless technologies such as a wireless local area network (WLAN) and Bluetooth, and the like. Binary CDMA technology is also designed to resolve a quality of service (QoS) related problem. For example, a Koinonia system, based on the binary CDMA technology and approved as an international standard by the ISO/IEC JTCSC6 in January, 2009, has interoperability with various prior technologies, provides QoS under noisy wireless environment, and generally does not interfere with an existing communication system. Recently, a Guardian technology, applied with a wireless encryption technology, is under development based on the binary CDMA technology. Also, various research projects for adapting the guardian technology to various wireless communication systems are currently actively in progress.

However, various security threats are increasing in the wireless communication environment. As a result, security breaches occur, for example, private and public information leakage, or system damage, and the like. Although security-enhanced IEEE 802.11i is recommended for IEEE 802.11 WLAN, it might not provide expected security due to cost or management. The use of limited and embedded secure functions over a public network is continuously increasing. Thus, the number of security breaches over an IEEE 802.11 WLAN are also increasing.

Also, it is obligatory to apply encryption technology for security of products over a public network. Therefore, there is a need for increased security for information that is accessed over a communication network.

### BRIEF DESCRIPTION OF THE DRAWINGS

FIG. 1 is a diagram illustrating an example of a communication system.

FIG. 2 is a diagram illustrating an example of a Binary CDMA LAN (BLAN).

FIG. 3 is a diagram illustrating examples of handovers in a wireless communication network.

FIG. 4 is a diagram illustrating an example of an authentication protocol key structure.

FIG. 5 is a diagram illustrating an example of a BLAN-AKA process.

FIG. 6 is a diagram illustrating a key authentication process of BLAN-AKA.

FIG. 7 is a diagram illustrating a re-authentication process.

Throughout the drawings and the detailed description, unless otherwise described, the same drawing reference numerals will be understood to refer to the same elements, features, and structures. The relative size and depiction of these elements may be exaggerated for clarity, illustration, and convenience.

### SUMMARY

In one general aspect, provided is a method of a user equipment (UE) for authenticating a key in a system, the system including the UE includes a master key for authentication, a serving network (SN) that comprises a radio access point (RAP) and a visitor location register (VLR), and a home network that comprises an authentication server and a home location register (HLR), the method comprising receiving a terminal authentication request message from the RAP, transmitting a terminal authentication response message that includes identification information of the UE, receiving a user authentication request message that includes at least two random numbers and a code information for message authentication from the RAP, and transmitting a user authentication response message that includes first information generated using the code information, the master key, and at least one random number of the received at least two random numbers.

The identification information may be one of permanent identification information or temporary identification information, and the temporary identification information is transmitted from the VLR.

The at least two random numbers may include a first random number that is generated by the HLR and a second random number that is generated by the VLR.

The UE may generate a temporary key using the master key and the first random number, and may generate a session key using the temporary key and at least one other random number of the received at least two random numbers.

The UE and the serving network may perform communications using binary CDMA.

In another aspect, provided is a method of a serving network (SN) for authenticating a key in a system, the system including a user equipment (UE) that includes a master key for authentication, the serving network (SN) that includes a wireless access point (RAP) and a visitor location register (VLR), and a home network that includes an authentication server and a home location register (HLR), the method comprising transmitting a terminal authentication request message to the UE, receiving a terminal authentication response message that includes an identification information of the UE, transmitting, to the home network, an authentication data request message that includes the received identification information, receiving, from the home network, an authentication data response message that includes a first random number, a temporary key, and first information, and transmitting, to the UE, a user authentication request message that includes the first random number, a second random number and code information for message authentication.

The identification information of the UE may be one of permanent identification information or temporary identification information, and the temporary identification information is transmitted from the VLR.

The first random number may be generated by the HLR and the second random number is generated by the VLR.

The code information for message authentication may be generated using the second random number and the temporary key.

The first information may be generated by home network using the master key and the first random number, and the user authentication response message may comprises second information that is generated by the UE using the master key and the first random number.

The VLR may generate a third random number for re-authentication of a key.

Other features and aspects will be apparent from the following detailed description, the drawings, and the claims.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

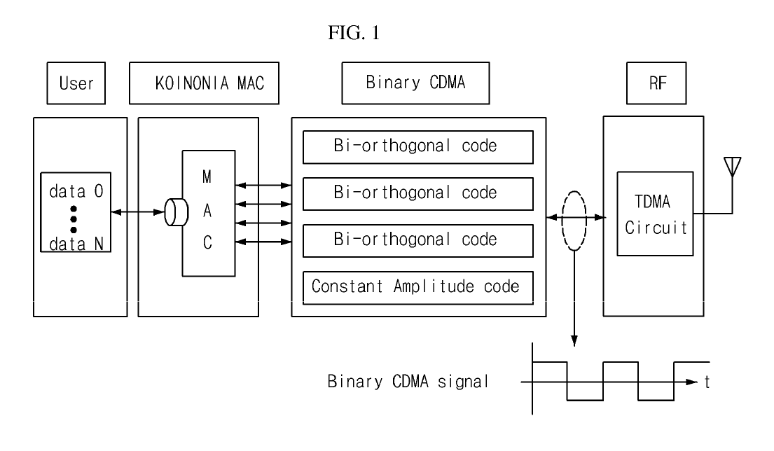

FIG. 1 illustrates an example of a communication system. The communication system may be, for example, a Koinonia system. The communication system includes a physical layer and data link layer. The data link layer has a media access control sub-layer and an adaptation sub-layer. The media access control sub-layer may use Hybird multiple access (HMA) mode that performs media access through a combination of code and time, based on the characteristics of the binary CDMA of the physical layer. The binary CDMA has a structure that binarizes modulated signals of various levels generated according to multiple-code CDMA, and transmits the modulated signals as TDMA signals. The binary CDMA is robust against noise and the TDMA consumes less power and has a high speed transmission capacity. The adaptation sub-layer interconnects between lower protocol stacks and higher protocol stacks of other wireless standards.

The communication system provides QoS in a noisy wireless environment, provides interoperability by combining various digital devices into one network, and is interference-free to other communication systems when the communication system and the other communication systems coexist. The communication system described herein overcomes the problems of prior short range wireless communication technologies such as Bluetooth, IEEE 802.11b, and the like, by providing interference-free communication in a complex wireless environment and also reduces power consumption.

Table 1 illustrates the characteristics of various short range wireless communication technologies.

TABLE 1

| | Koinonia | Bluetooth | IEEE 802.11b | UWB |
|---|---|---|---|---|
| Service | 10~100 m | 10~100 m | 10~100 m | 1~10 m |
| range | | | | |
| QoS | ◯ | Δ | X | Δ |
| Module | Binary | FHSS:GFSK | DSSS:QPSK/ | CDMA:PSK |
| | CDMA | | CCK | DFDM:QPSK |
| Network | Ad-hoc/ | Ad-hoc | Ad-hoc/Infra | Ad-hoc/Infra |
| Topology | Infra | | | |
| Leading | Korea | Japan | U.S.A | U.S.A |
| country of | | | | |
| International | | | | |
| Standard | | | | |

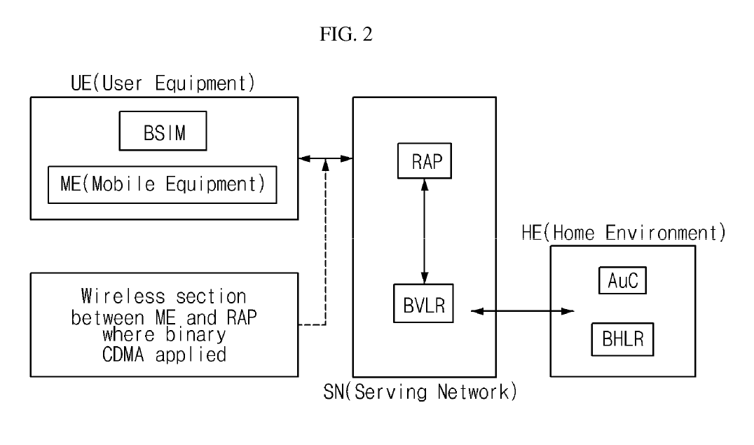

FIG. 2 illustrates an example of a Binary CDMA LAN (BLAN). The BLAN may include a wired connection and/or a wireless connection. In this example, the BLAN includes user equipment (UE), a serving network (SN), and a home environment/home network (HE. In this example, the UE and SN are interconnected through a wireless network. Also, in this example the SN and HE are interconnected through a wired network.

In this example, the UE includes a Binary CDMA Subscriber Identity Module (BSIM) and Mobile Equipment (ME). The BSIM is a device for identifying and authenticating subscribers. That is, the BSIM has one or more encryption algorithms for user authentication and service profile of subscriber. The ME is a device that provides an interface for physical connections, wireless connections, and an interface for interaction with BSIM.

The SN is for providing various services to users and includes a Radio Access Point (RAP), and a BLAN Visitor Location Register (BVLR). The RAP is an access device for connecting a user to a network, and provides a wireless interface to the ME using binary CDMA. For example, the RAP may be a wireless access point of a network. The BVLR manages RAPs in its own area, and provides authentication services to users through interaction with the HE.

BVLR may enhance overall network security by minimizing direct exposure of important confidential information such as user information, authentication information, and the like, by preventing direct authentication of a RAP that is exposed to relatively more physical security threats. The BVLR may perform substantive authentication processes, enable re-authentication protocol in accordance with handover, and provide high mobility by managing a handover between RAPs in the same BVLR. BVLR is also adaptive in adding partial small networks. A network that includes one BVLR and one or more RAPs may be added to particular area and may be managed by different security level in comparison with connected network.

The HE may include private information and authority information of user and the HE may support a BLAN Authentication and Key Agreement (BLAN-AKA) mechanism. In this example, the HE includes a BLAN Home Location Register (BHLR) and AN authentication server (AuC). The BHLR includes a database for managing users. The BHLR maintains subscriber profiles and related information, and information relates to the BVLR. The AuC stores data that is required for authentication of each user, for example, encryption and integrity information, stores functions for generating master key (MK) that is distributed to each user and required other keys, and generates data that is required for authentication when a user requests authentication. The BHLR and the AuC may be implemented into the same physical device.

As mentioned above, the BLAN is a network that may include both wired and wireless networks. Regarding the BLAN, wireless communication between UE and SN should be secure. From a security point of view, communication between SN and HE is not substantially different from prior wired networks, and communication part between RAP and BVLR in SN may be merely considered as extension of the communication between SN and HE. Therefore, the secure channels are established in wired communication part of BLAN and safety of mutual authentication and all communication is ensured among each entity in wired communication part of BLAN.

The mutual authentication may include the SN authorizing authentication from the UE and the HE. A communication network between UE and SN is may be use to perform the mutual authentication. The authentication is performed through message exchanges between a user and a network. After the authentication the user may trust the connected network.

Secrecy may be divided into 2 types, one is user secrecy and the other is user-data secrecy. The user secrecy may use temporal identification information instead of ID of the user for the protection of user location information and user related private information.

The user-data secrecy may be used for the protection of the data between the UE and the RAP. The user-data secrecy may be implemented using a block encryption algorithm after successful completion of authentication.

Integrity may be used to authenticate the origin and content of a message. To investigate whether unintended or intended changes of message content exist, an integrity check algorithm may be implemented using a Message Authentication Code (MAC) algorithm.

Handovers are performed to provide continuity of service in a wireless network. The BLAN performs a handover when an UE is moving from one RAP to another RAP. For more frequent handovers, it may be better to define a new authentication protocol, and re-authentication protocol, which are different from the AKA protocol.

However, it might be inefficient to apply same re-authentication protocol to all kinds of handovers. Therefore, handover type may be identified before applying re-authentication protocol.

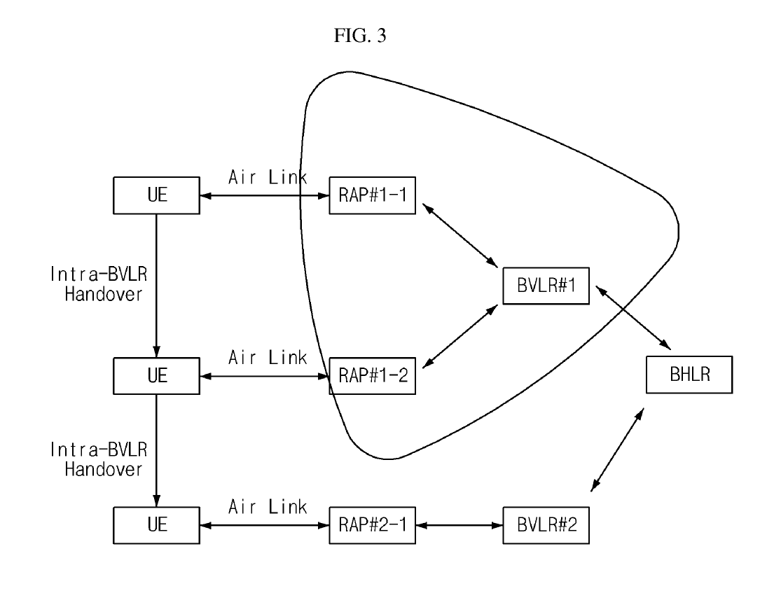

FIG. 3 illustrates two examples of handovers. In this example, the Intra-BVLR handover is handover performed in one BVLR. That is, the Intra-BVLR handover is the handover that is performed when UE is moving among RAPs of one BVLR. According to FIG. 3, the Intra-BVLR handover takes place when the UE is moving from RAP#1-1 to RAP#1-2 or from RAP#1-2 to RAP#1-1.

Inter-BVLR handover means the handover between two RAPs that are connected to different BVLRs. In the Inter-BVLR handover case, authentication to a new BVLR is performed. During Inter-BVLR handover, acquisition of information for authentication from the prior BVLR or new AKA process using BHLR may be used. In the former case, a new secure channel may be used. The new channel may be used only when a handover takes place. For network efficiency, the latter authentication method that uses existing channel between BVLR and BHLR may be performed. In the Inter-BVLR handover, it may be more efficient to perform another AKA process rather than to perform re-authentication process.

TABLE 2 shows characteristics of two handovers.

TABLE 2

| | Intra-BVLR handover | Inter-BVLR handover |
|---|---|---|
| Definition | Movement among different | Movement among RAPs |
| | RAPs in one BVLR | that are connected to |
| | | different BVLR |
| Possibility of | High | Low |
| taking place of | | |
| handover | | |
| Authentication | Re-authentication protocol | BLAN-AKA |
| Protocol | | |
| Key update | TK: not necessary | TK: necessary |
| | SK: necessary | SK: necessary |

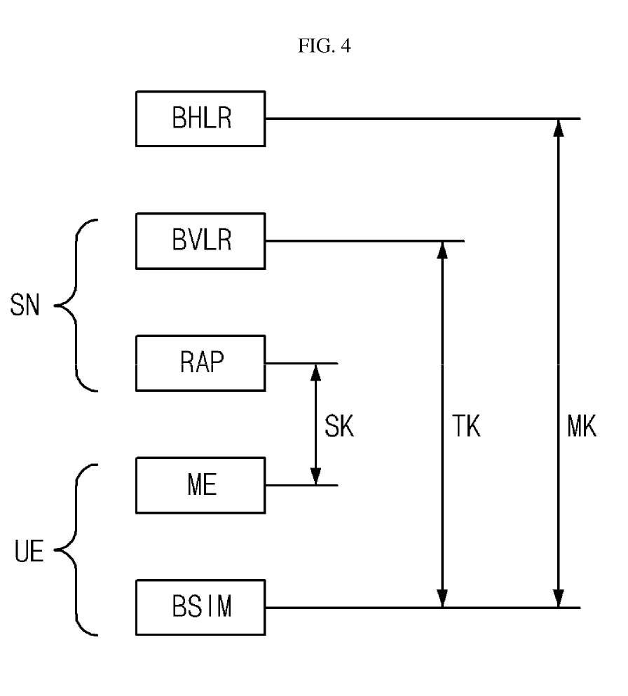

FIG. 4 illustrates an example of authentication protocol keys. In this example, the keys used in the authentication protocol may be categorized into 3 types, a master key (MK), a temporary key (TK), and a session key (SK). The MK is a secret key that BHLR and BSIM share beforehand, and includes a secret value for mutual authentication between a user and a network. This secret value is not disclosed to medium entities such as the BVLR, the RAP, and the ME. The TK is a temporary key originated from the MK, and is used for re-authentication in a handover. For example, the TK may be generated by BHLR and transmitted to BVLR in AKA process. The TK is a secret key that BSIM and BVLR share. The SK is a product of success authentication, is a key that is used to protect the traffic of wireless communication that uses binary CDMA.

AKA is a process for performing mutual authentication and key confirmation between a user and a network. The AKA process should be performed for ensuring integrity and security of traffics.

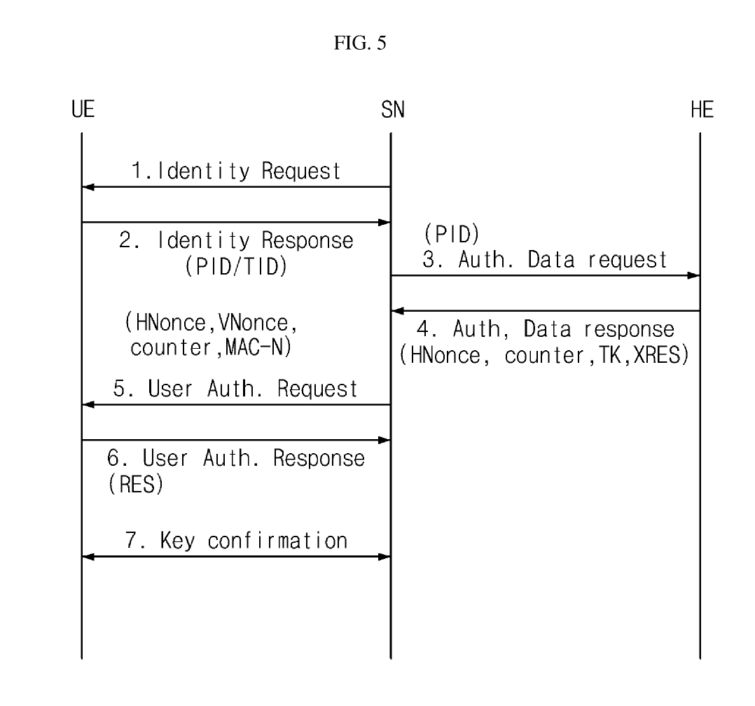

FIG. 5 illustrates an example of a BLAN-AKA process.

The process includes the following:

Referring to FIG. 5, the SN transmits a terminal authentication request message (identity request) to the UE. Then, the RAP relays only communications between the UE and the BVLR until session key (SK) is received from BVLR.

After receiving terminal authentication request message (identity request message), the UE transmits a terminal authentication response message (identity response message) to the SN. The terminal authentication response message (identity response message) comprises a (Permanent ID: permanent user ID (PID) or a Temporary ID: Temporary user ID (TID). The PID is permanent identification of a user which is registered to the HE through the BSIM. The TID is a temporary identification that is received from a mutually authenticated SN through the former AKA process. The TID may be used to protect the secrecy of a user location by hiding the PID.

The BVLR transmits the PID received from the UE to the BHLR to acquire user data that may be used for the AKA process. After the BVLR receives the TID, the BVLR finds a PID that matches to the received TID and transmits the PID to the BHLR. If the BVLR does not find the PID that matches the received TID, the BVLR requests transmission of the PID to the UE and the process returns to the UE transmitting a terminal authentication response message. After receiving the PID, the BHLR generates a random number, for example, ‘HNonce,’ which corresponds to the BHLR and calculates the TK using a Key Derivation Function (KDF) and an authorized data response (XRES) using the Message Authentication Code (MAC). Then, the BHLR transmits HNonce, TK, XRES, and the counter to the BVLR. The counter is similar to SQN in 3GPP.

TK=KDF(MK,HNonce,counter)

XRES=MAC(MK,HNonce,counter) [Formula 1]

After receiving the data, the BVLR authenticates the user. That is, the BVLR authorized by BHLR authenticates the user using BLAN-AKA protocol. For the user authentication, the BVLR generates a random number, for example, VNonce, which corresponds to itself (BVLR) and calculates a Message Authentication Code (MAC) using the VNonce and the TK. The user authenticates networks, that is, the SN and the HE using MAC-N. The BVLR transmits the HNonce, VNonce, MAC-N and counter to the UE using AKA request message.

MAC-N=MAC(TK,VNonce,counter) [Formula 2]

The UE authenticates the network by confirming MAC-N. If the UE fails to authenticate the network, the UE transmits authentication a denial message to the network and terminates the connection. If the UE successfully authenticates the network, the UE confirms whether the received counter is within allowable range. If the counter is not within the allowable range, the UE transmits a resynchronization request message for the resynchronization of the counter to the BVLR, and the BVLR notifies the reception of the resynchronization request message to the BHLR. The BHLR updates the counter through checking the integrity of the message and may start a new AKA process. If the counter is within the allowable range, the BSIM updates its own counter and generates a session key SK using VNonoce. The BSIM calculates a user authorized response (RES) for the authentication of itself and transmits the RES to the BVLR using the AKA response message.

SK=KDF(TK,VNonce,counter)

RES=MAC(MK,HNonce,counter) [Formula 3]

The BVLR authenticates the user by confirming whether the XRES and the RES are the same. If the BVLR successfully authenticates the user, the BVLR generates the SK using VNonce and TK, and transmits the SK to the RAP. The BVLR also transmits ANonce which is used in the key confirmation process when the BVLR transmits the SK. Because ANonce is also used in the re-authentication process, it is more efficient that the BVLR generates ANonce and transmits it to the RAP rather than the RAP generating ANonce. The BSIM of the UE transmits the SK to the ME.

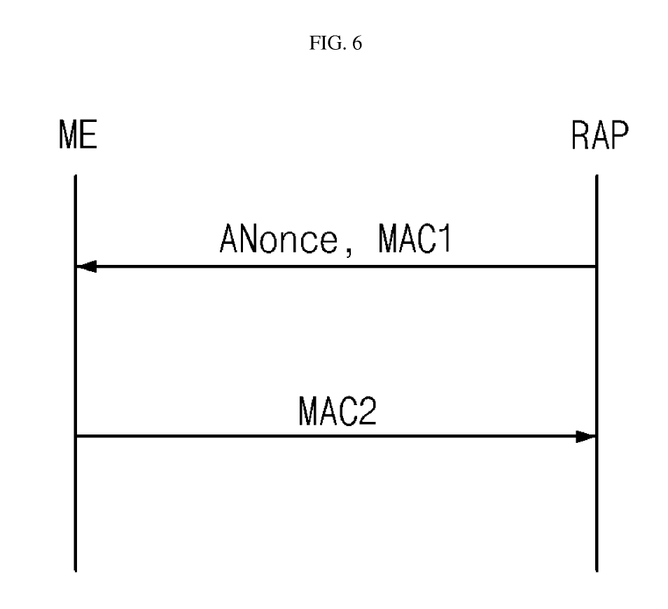

The UE and the RAP perform a key confirmation process to confirm whether the SK that the UE received and the SK that the RAP received are the same. The key confirmation process may be performed using a security algorithm for protecting traffics to be transmitted or received. FIG. 6 illustrates the key confirmation process of the BLAN-AKA.

MAC1=mac(SK,ANonce)

MAC2=mac(SK,ANonce+1) [Formula 4]

After successful completion of the BLAN-AKA, the BVLR and the UE, respectively, store the TK and the ANonce that are shared during AKA process for potential re-authentication. The BVLR notifies successful completion of the AKA process to the BHLR, and then the BHLR updates the counter.

When frequent handovers take place, re-authentication may reduce overhead so as to enable a faster and more efficient handover. Re-authentication may be performed using the secret value that is shared by the BSIM and the BVLR. The TK in the BLAN-AKA protocol is one example of the secret value. The TK may be updated through the AKA process, and authentication may be performed using the TK when a handover between RAPs of the same BVLR occur.

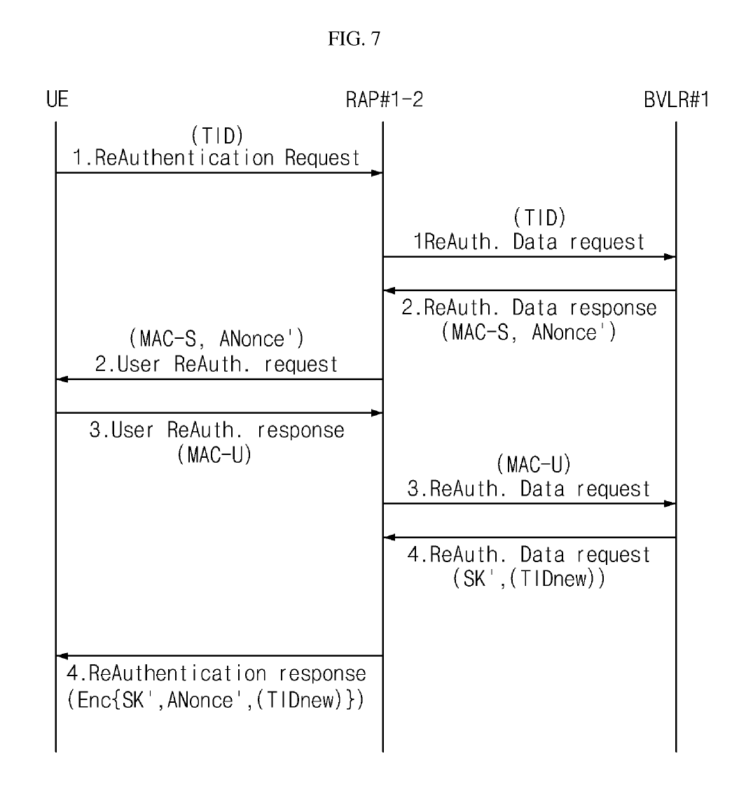

FIG. 7 illustrates a re-authentication process. In this example, the intra-BVLR handover takes place when RAP#1-1 and RAP#1-2 are connected to the same BVLR, for example, when the BVLR#1 and the UE moves from RAP#1-1 to RAP#1-2. An AKA RAP receives a SK′ from the BVLR and relays communications between the UE and the BVLR.

The UE transmits a TID (temporary ID) to the BVLR for re-authentication when Intra-handover takes place.

The BVLR searches for a PID that corresponds to the TID, generates a new session key SK′ using the TK and ANonce that are stored during AKA process, and transmits the newly generated ANonce′ to the UE. In comparison with the AKA process, the MAC-S is similar to the MAC1 that are used in key confirmation process. Only the SK′ and the ANonce′ are used instead of the SK and the ANonce.

SK′=KDF(TK,ANonce)

MAC-S=MAC(SK′,ANonce′) [Formula 5]

Like the BVLR, the UE generates the SK′ using the TK and the ANonce that are stored during the former AKA process and the ANonce′ received from BVLR, and verifies the MAC-S. If the MAC-S is verified, the UE calculates the MAC-U and transmits the calculated MAC-U to the BVLR as a response.

MAC-U=MAC(SK′,ANonce′+1) [Formula 6]

If the BVLR is successfully verifies the received MAC-U, the BVLR transmits an encrypted value that is ANonce′ encrypted by SK′, and transmits to UE. If reallocation of TID is necessary, TIDnew, a new TID vale, is encrypted and transmitted, too.

The following is a comparison between the re-authentication process and the AKA process. The AKA process uses formula 7 and the re-authentication process uses formula 8.

SK=KDF(TK,VNonce,counter)

MAC1=mac(SK,ANonce)

MAC2=mac(SK,ANonce+1) [Formula 7]

SK′=KDF(TK,ANonce)

MAC-S=MAC(SK′,ANonce′)

MAC-U=MAC(SK′,ANonce′+1) [Formula 8]

In re-authentication, the ANonce is used instead of the VNonce and ANonce′ is used instead of ANonce. For example, the Nonce used in the key confirmation process in the AKA process is used to perform key derivation in a future re-authentication. After the completion of the re-authentication, the ANonce′ may be used to generate a new session key in next re-authentication.

Therefore, UE and BVLR update the ANonce to ANonce′ after the completion of the re-authentication.

TABLE 3 shows comparison results between the BLAN-AKA and the re-authentication protocol.

TABLE 3

| | | BLAN-AKA | Re-authentication |
|---|---|---|---|
| Number of Message transmission | | 12 (wireless | 8 (wireless |
| | | transmission 5) | transmission 4) |
| Number of algorithm | MAC/mac | 8 | 4 |
| calculation | KDF | 4 | 2 |

The number of message transmissions counted after the UE starts to transmit the PID or the TID is 12, and the BLAN-AKA process further notifies the completion of authentication to the BHLR after the completion of authentication. The reductions of message transmission number and calculation number in re-authentication protocol are based on the re-authentication protocol and simultaneous performance of authentication and key exchange. In re-authentication, a key confirmation process is unnecessary because the session key SK′ is verified through authentication.

Unlike a WLAN that performs terminal authentication, a BLAN performs authentication that is similar to user authentication using a BSIM that is similar to a USIM. This enhances terminal usage efficiency, and strong protection of individual privacy.

In a BLAN re-authentication protocol, a BSIM and a BVLR may generate a session key SK′ in advance. The SK′ may be used in a future re-authentication using ANonce and TK that are used in former authentication. Therefore, the BLAN re-authentication protocol supports faster authentication and the BLAN using a BLAN re-authentication protocol may efficiently handle frequent handovers.

In a BLAN-AKA process, the possibility of resynchronization is very low, because BHLR transmits only one authentication data according to the requests of BVLRs that are located in proximity to each other and BSIM and BHLR perform updates only after the completion of successful BLAN-AKA process.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of a user equipment (UE) for authenticating a key in a system, the system including the UE includes a master key for authentication, a serving network (SN) that comprises a radio access point (RAP) and a visitor location register (VLR), and a home network that comprises an authentication server and a home location register (HLR), the method comprising:
receiving a terminal authentication request message from the RAP;
transmitting a terminal authentication response message that includes identification information of the UE;
receiving a user authentication request message that includes at least two random numbers and a code information for message authentication from the RAP; and
transmitting a user authentication response message that includes first information generated using the code information, the master key, and at least one random number of the received at least two random numbers.

2. The method of claim 1, wherein the identification information is one of permanent identification information or temporary identification information, and the temporary identification information is transmitted from the VLR.

3. The method of claim 1, wherein the at least two random numbers include a first random number that is generated by the HLR and a second random number that is generated by the VLR.

4. The method of claim 3, wherein the UE generates a temporary key using the master key and the first random number, and generates a session key using the temporary key and at least one other random number of the received at least two random numbers.

5. The method of claim 1, wherein the UE and the serving network perform communications using binary CDMA.

6. A method of a serving network (SN) for authenticating a key in a system, the system including a user equipment (UE) that includes a master key for authentication, the serving network (SN) that includes a wireless access point (RAP) and a visitor location register (VLR), and a home network that includes an authentication server and a home location register (HLR), the method comprising:
transmitting a terminal authentication request message to the UE;
receiving a terminal authentication response message that includes an identification information of the UE;
transmitting, to the home network, an authentication data request message that includes the received identification information;
receiving, from the home network, an authentication data response message that includes a first random number, a temporary key, and first information; and
transmitting, to the UE, a user authentication request message that includes the first random number, a second random number and code information for message authentication.

7. The method of claim 6, wherein the identification information of the UE is one of permanent identification information or temporary identification information, and the temporary identification information is transmitted from the VLR.

8. The method of claim 6, wherein the first random number is generated by the HLR and the second random number is generated by the VLR.

9. The method of claim 8, wherein the code information for message authentication is generated using the second random number and the temporary key.

10. The method of claim 8, wherein the first information is generated by home network using the master key and the first random number, and the user authentication response message comprises second information that is generated by the UE using the master key and the first random number.

11. The method of claim 10, wherein the VLR generates a third random number for re-authentication of a key.
